(19) United States
(12) Patent Application Publication
(10) Pub. No.: US 2007/0194684 A1
(43) Pub. Date: Aug. 23, 2007

(54) Light emitting diode structure

(76) Inventors: Yi-Yi Chen, Tainan (TW); Chun-Liang Lin, Gueiren Township (TW); Ren-Feng Huang, Neimen Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/357,046

(22) Filed: Feb. 21, 2006

(51) Int. Cl. H01J 29/10

(52) U.S. Cl. 313/463

(57) ABSTRACT

A light source is positioned so as to face a highly light-pervious side of a unidirectional highly pervious lens, which has a highly reflective side on the other side; the highly reflective side of the unidirectional highly pervious lens is coated with a fluorescent material; therefore, when light emitted from the light source travels to the fluorescent material through the highly light-pervious side and the highly reflective side, the fluorescent material will be excited to produce dispersion of light, and the highly reflective side of the unidirectional highly pervious lens will reflect those light beams of dispersed light from the fluorescent material that head towards the light source.

### BACKGROUND OF THE INVENTION

1. Field of the Invention

The present invention relates to an improvement on light emitting diode structure, more particularly one, which is equipped with a unidirectional highly pervious lens for preventing dispersion of light when fluorescent material is excited with light from a light source, thus having increased lighting efficiency and service life.

2. Brief Description of the Prior Art

Currently existing technology makes white light emitting diodes produce white light by means of exciting fluorescent powder, which is held in chips after chip assembling, with blue light or ultraviolet light. However, resonance is prone to happen between the fluorescent powder and the assembled chips, which will cause the fluorescent powder to become yellow. Consequently, the service life of white light emitting diodes will reduce.

To prevent the above-mentioned disadvantage, a new method is developed, according to which method a piece of glass is coated with fluorescent powder, and blue light emitting diodes are used to excite the fluorescent powder to produce white; thus, light emitting diodes are available, which can produce white light highly efficiently and have long service life. However, after the fluorescent powder is excited with the blue light emitting diodes, there will be significant amount of exciting light reflected back to the blue light emitting diodes, and in turn light-dispersion happens. Consequently, lighting efficiency and service life of the light emitting diodes reduces.

### SUMMARY OF THE INVENTION

It is a main object of the invention to provide an improvement on a light emitting diode to overcome the above-mentioned problems.

In the present invention, a light source is positioned so as to face a highly light-pervious side of a unidirectional highly pervious lens, which has a highly reflective side on the other side. The highly reflective side of the unidirectional highly pervious lens is coated with a fluorescent material. Therefore, when light emitted from the light source travels to the fluorescent material through the highly light-pervious side and the highly reflective side, the fluorescent material will be excited to produce dispersion of light, and the highly reflective side of the unidirectional highly pervious lens will reflect those light beams of dispersed light emitted from the fluorescent material that head towards the light source, and in turn lighting efficiency and service life of the light emitting diode increases.

### BRIEF DESCRIPTION OF THE DRAWINGS

The present invention will be better understood by referring to the accompanying drawings, wherein:

FIG. 1 is a view of the first preferred embodiment in the present invention,

FIG. 2 is an enlarge partial view of the first preferred embodiment,

FIG. 3 is a view of the second preferred embodiment,

FIG. 4 is a view of the third preferred embodiment, and

FIG. 5 is a view of the fourth preferred embodiment.

### DETAILED DESCRIPTION OF THE PREFERRED EMBODIMENTS

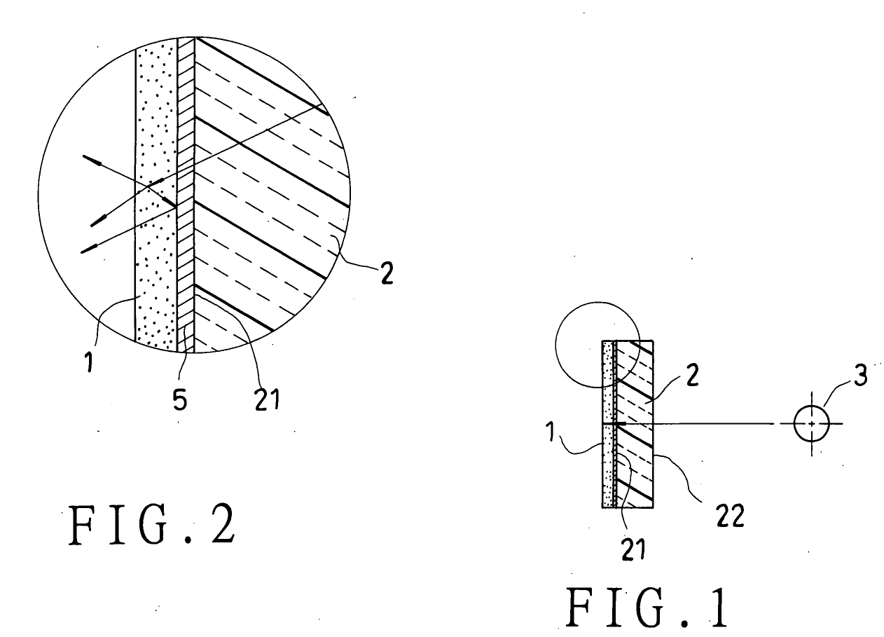

Referring to FIGS. 1 and 2, a first preferred embodiment of a light emitting diode includes a fluorescent material 1, a unidirectional highly pervious lens 2, and a light source 3. The unidirectional highly pervious lens 2 has a highly reflective side 21, and a highly light-pervious side 22, both of which face in opposite directions. The highly reflective side 21 of the unidirectional highly pervious lens 2 is coated with the fluorescent material 1; the fluorescent material 1 can be directly applied or precipitated over the highly reflective side 21. The light source 3 is positioned so as to face the highly light-pervious side 22 of the unidirectional highly pervious lens 2. When light emitted from the light source 3 travels to the fluorescent material 1 through the highly light-pervious side 22 and the highly reflective side 21 of the unidirectional highly pervious lens 2, the fluorescent material 1 will be excited to produce dispersion of light in all directions, and the highly reflective side 21 of the unidirectional highly pervious lens 2 will reflect those light beams of the dispersed light from the fluorescent material 1 that head towards the light source 3.

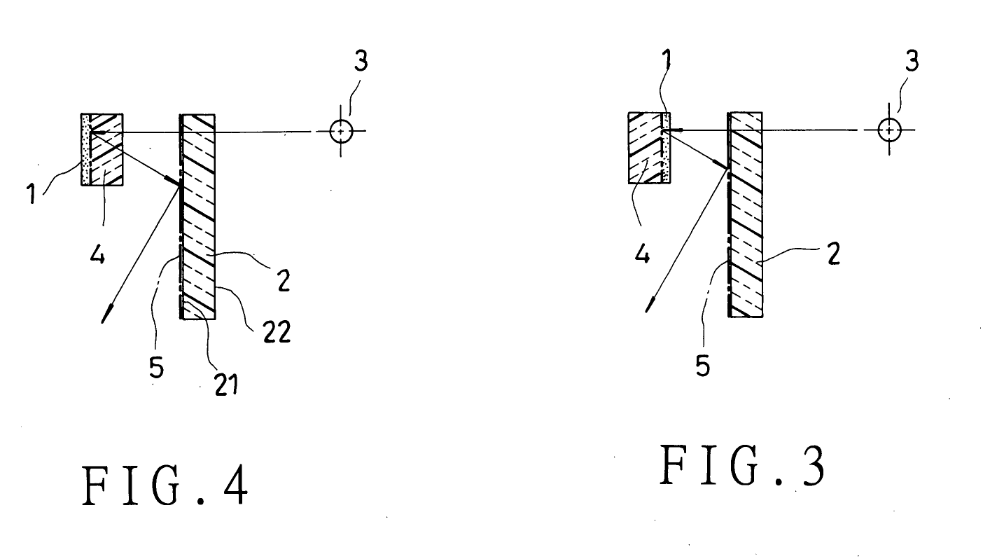

FIGS. 3 and 4 show second and third preferred embodiments of the present invention; a lens 4 is coated with a fluorescent material 1 on any one of two sides thereof, and a unidirectional highly pervious lens 2, which has a highly reflective side 21, and a highly light-pervious side 22, is positioned such that the highly reflective side 21 thereof faces one side of the lens 4; furthermore, a light source 3 is positioned so as to face the highly light-pervious side 22 of the unidirectional highly pervious lens 2. When light emitted from the light source 3 travels to the fluorescent material 1 through the unidirectional highly pervious lens 2 and the lens 4, the fluorescent material 1 will be excited to produce dispersion of light in all directions. Consequently, the highly reflective side 21 of the unidirectional highly pervious lens 2 will reflect those light beams of the dispersed light emitted from the fluorescent material 1 that head towards the light source 3.

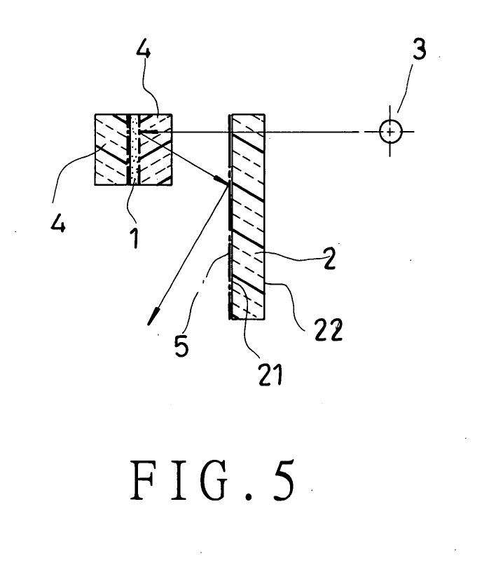

FIG. 5 shows a fourth preferred embodiment of the present invention; a fluorescent material 1 is sandwiched between two lenses 4, and a unidirectional highly pervious lens 2, which has a highly reflective side 21, and a highly light-pervious side 22, is positioned such that the highly reflective side 21 thereof faces one of the lenses 4; furthermore, a light source 3 is positioned so as to face the highly light-pervious side 22 of the unidirectional highly pervious lens 2. When light emitted from the light source 3 travels to the fluorescent material 1 through the unidirectional highly pervious lens 2 and that one of the lenses 4 that faces the highly reflective side 21, the fluorescent material 1 will be excited to produce dispersion of light in all directions, and light emitted from the light source 3 will pass through the other one of the lenses 4 finally. Consequently, the highly reflective side 21 of the unidirectional highly pervious lens 2 will reflect those light beams of the dispersed light from the fluorescent material 1 that head towards the light source 3.

The material of the unidirectional highly pervious lens 2 can be plastic, glass, other transparent substances or other semitransparent substances. Furthermore, the ratio of light passing through the highly light-pervious side 22 to that passing through the highly reflective side 21 of the unidirectional highly pervious lens 2 is greater than 50%. Basically, the highly reflective side 21 is made by means of coating the unidirectional highly pervious lens 2 with a highly reflective film 5 (FIG. 2), which is made of a compound material of titanium dioxide and silicon oxide, and of which the thickness is no greater than 100 nanometers (nm).

From the above description, it can be seen that after excitation of the fluorescent material 1 by light emitted from the light source 3, the highly reflective side 21 of the unidirectional highly pervious lens 2 will reflect those light beams of the dispersed light from the fluorescent material 1 that head towards the light source 3 such that the service life of the light emitting diode of the present invention increases.

What is claimed is:

1. An improvement on light emitting diode structure, comprising
a unidirectional highly pervious lens, the unidirectional highly pervious lens having a highly reflective side, and a highly light-pervious side;
a light source, the light source being positioned so as to face the highly light-pervious side of the unidirectional highly pervious lens; and
a fluorescent material over the highly reflective side of the unidirectional highly pervious lens;
when light emitted from the light source travels to the fluorescent material through the highly light-pervious side and the highly reflective side, the fluorescent material being going to be excited to produce dispersion of light in all directions, and the highly reflective side of the unidirectional highly pervious lens being going to reflect those light beams of dispersed light from the fluorescent material that head towards the light source.

2. The improvement on light emitting diode structure as recited in claim 1, wherein ratio of light passing through the highly light-pervious side to that passing through the highly reflective side of the unidirectional highly pervious lens is greater than 50%.

3. The improvement on light emitting diode structure as recited in claim 1, wherein the highly reflective side is made by means of coating the unidirectional highly pervious lens with a highly reflective film.

4. The improvement on light emitting diode structure as recited in claim 3, wherein the highly reflective film is made of a compound material of titanium dioxide and silicon oxide.

5. The improvement on light emitting diode structure as recited in claim 4, wherein thickness of the highly reflective film is no greater than 100 nanometers.

6. An improvement on light emitting diode structure, comprising
a unidirectional highly pervious lens, the unidirectional highly pervious lens having a highly reflective side, and a highly light-pervious side;
a light source, the light source being positioned so as to face the highly light-pervious side of the unidirectional highly pervious lens;
a second lens, the lens being positioned in front of the unidirectional highly pervious lens; and
a fluorescent material over one of two sides of said second lens;
whereby when light emitted from the light source travels to the fluorescent material through the unidirectional highly pervious lens and said second lens, the fluorescent material will be excited to produce dispersion of light in all directions, and the highly reflective side of the unidirectional highly pervious lens will reflect those light beams of dispersed light from the fluorescent material that head towards the light source.

7. The improvement on light emitting diode structure as recited in claim 6, wherein ratio of light passing through the highly light-pervious side to that passing through the highly reflective side of the unidirectional highly pervious lens is greater than 50%.

8. The improvement on light emitting diode structure as recited in claim 6, wherein the highly reflective side is made by means of coating the unidirectional highly pervious lens with a highly reflective film.

9. The improvement on light emitting diode structure as recited in claim 8, wherein the highly reflective film is made of a compound material of titanium dioxide and silicon oxide.

10. The improvement on light emitting diode structure as recited in claim 9, wherein thickness of the highly reflective film is no greater than 100 nanometers.

11. An improvement on light emitting diode structure, comprising
a unidirectional highly pervious lens, the unidirectional highly pervious lens having a highly reflective side, and a highly light-pervious side;
a light source, the light source being positioned so as to face the highly light-pervious side of the unidirectional highly pervious lens;
two second lenses, the lenses being positioned in front of the unidirectional highly pervious lens; and
a fluorescent material, the fluorescent material being sandwiched between said two second lenses;
whereby when light emitted from the light source travels to the fluorescent material through the unidirectional highly pervious lens and one of said second lenses, the fluorescent material will be excited to produce dispersion of light in all directions, and the highly reflective side of the unidirectional highly pervious lens will reflect those light beams of dispersed light from the fluorescent material that head towards the light source.

12. The improvement on light emitting diode structure as recited in claim 11, wherein ratio of light passing through the highly light-pervious side to that passing through the highly reflective side of the unidirectional highly pervious lens is greater than 50%.

13. The improvement on light emitting diode structure as recited in claim 11, wherein the highly reflective side is made by means of coating the unidirectional highly pervious lens with a highly reflective film.

14. The improvement on light emitting diode structure as recited in claim 13, wherein the highly reflective film is made of a compound material of titanium dioxide and silicon oxide.

15. The improvement on light emitting diode structure as recited in claim 14, wherein thickness of the highly reflective film is no greater than 100 nanometers.
